(19) United States
(12) Patent Application Publication
(10) Pub. No.: US 2010/0128049 A1
(43) Pub. Date: May 27, 2010

(54) METHOD AND SYSTEM FOR VISUALIZING MONOCHROMATIC IMAGES IN COLOR HUE

(75) Inventors: Emil Georgiev, Hartland, WI (US); Gopal Avinash, New Berlin, WI (US); Erik Kemper, Waukesha, WI (US)

Correspondence Address: PETER VOGEL;GE HEALTHCARE, 20225 WATER TOWER BLVD., MAIL STOP W492, BROOKFIELD, WI, 53045, US

(73) Assignee: General Electric Company, Schenectady, NY (US)

(21) Appl. No.: 12/277,967

(22) Filed: Nov. 25, 2008

(51) Int. Cl. G09G 5/02

(52) U.S. Cl. 345/589

(57) ABSTRACT

A method and system for visualizing monochromatic images in color hue is disclosed herewith. The method comprises: obtaining an optimal monochromatic color wavelength corresponding to an effective light level, the effective light level being identified with reference to an ambient light level and a monitor light level. The monochromatic color wavelength is converted to corresponding to a color hue and is incorporated to a gray scale map of an image to provide a colored view of the image.

### FIELD OF THE INVENTION

This invention relates generally to visualization of monochromatic images. More specifically, the invention provides a method for visualizing monochromatic images in color hue. The method and system are particularly useful in differentiating anatomy features in radiological images.

### BACKGROUND OF THE INVENTION

The ability of sensitivity of human eye to different parts of the visible light spectrum is different. It is known that human eyes have the ability to perceive more differentiation in luminosity i.e ability to differentiate shades of the same color, in the green and yellow-green portion of the visible spectrum than in any other spectrum region. Hence if images are displayed at a desired portion of the visual spectrum where the luminous efficacy is optimal, then the display may be visually more appealing and the ability to analyze and differentiate different parts of the image could be made easy.

Currently most of the digital radiological images are primarily viewed using gray scale methods, although the means exist to add color to these images. Color addition has been, however, typically done to indicate specific findings over the gray scale background. This has been due primarily to the historic nature of film-based imaging methods and the legacy they have left, even as we transition to digital imaging.

From the radiological image displayed using gray scale methods, it might be difficult to identify different parts of the image. The key problems in analyzing the radiological images are the sub-optimal conditions for review of digital radiology images that potentially results in diminished ability of radiologists and other clinicians to differentiate anatomy features in medical images, as well as increased eye fatigue and higher costs associated with diagnostic grade gray scale monitors.

Currently all radiology type images are viewed in gray scale utilizing color and special monochrome monitors, or, in case of films, light boxes. Special requirements and calibration standards are usually associated with electronic equipment used for diagnostic purposes (PACS monitors).

Currently, the issue is being addressed by increasing the luminosity of reading monitors in order to create differentiation.

Thus there exists a need to provide a method and device for visualizing monochromatic image in color hue without changing the setting of the monitor that displays the image.

### SUMMARY OF THE INVENTION

The above-mentioned shortcomings, disadvantages and problems are addressed herein which will be understood by reading and understanding the following specification.

An embodiment of the invention provides a method of visualization of monochromatic images on a monitor. The method comprises: obtaining an optimal monochromatic color wavelength corresponding to an effective light level, the effective light level being identified with reference to an ambient light level and a monitor light level. The optimal monochromatic color wavelength is converted to a color hue; and the color hue is incorporated to a gray scale map of an image to provide a colored view of the image.

In another embodiment, a method of displaying radiological images is disclosed. The method comprises: receiving an ambient light level and a monitor color level; obtaining an effective light level based on the ambient light level and the monitor light level; deriving an optimal monochromatic color wavelength corresponding to the effective light level; converting the optimal monochromatic color wavelength to color values; and applying the color values to a gray scale map of the radiological image.

In yet another embodiment, an image processing system configured to visualize monochromatic images in color hue is provided. The system comprises: a derivation module to derive an optimal monochromatic color wavelength with reference to an ambient light level and a monitor light level; a transformation module configured to convert the optimal monochromatic color wavelength to a color hue with reference to a spectrum range in the visual spectrum; and a coloring module configured to change gray scale map of the monochromatic image to a color map using the color hue; wherein the derivation module, transformation module and coloring module are configured to operate together to visualize the monochromatic images in color hue.

In yet another embodiment, a display system for displaying monochromic images is disclosed. The system comprises: a sensing assembly including: an ambient light sensor and a monitor light senor and a processor. The processor is configured to: derive an optimal monochromatic color wavelength with reference to an ambient light level and monitor light level and convert the optimal color monochromatic wavelength to a color hue with reference to a spectrum range in the visual spectrum and convert gray scale map of the image to a color map using the color hue. The system further comprises a color monitor configured to display the image with color map or a colored view of the image.

In yet another embodiment, a machine readable medium or media having recorded thereon instructions configured to instruct a system comprising: sensing assembly, a monitor and a processor to visualize monochromatic images in color hue comprising: a routine for obtaining an optimal monochromatic color wavelength corresponding to an effective light level, the effective light level being identified with reference to an ambient light level and a monitor light level; a routine for converting the optimal monochromatic color wavelength to color hue; and a routine for incorporating the color hue to a gray scale map of an image to provide a colored view of the image.

Various other features, objects, and advantages of the invention will be made apparent to those skilled in the art from the accompanying drawings and detailed description thereof.

### BRIEF DESCRIPTION OF THE DRAWINGS

FIG. 1 is a flowchart illustrating a method of displaying monochromatic images in a color monitor as described in an embodiment of the invention;

FIG. 2 is a flowchart illustrating a method of displaying radiological images as described in an embodiment of the invention;

FIG. 3 is a block diagram illustrating a display system configured to display monochromatic images as described in an embodiment of the invention;

FIG. 4 is a block diagram illustrating an image processing system configured to visualize monochromatic images in color hue as described in an embodiment of the invention;

FIG. 5 is a schematic representation of a display system configured to display monochromatic images as described in an embodiment of the invention; and

FIG. 6A to 6C illustrate an image in gray scale view and with image views in color at different region in the visible spectrum.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

Various embodiments of the present invention are directed to methods and systems for visualizing monochromatic images with color hue. This will facilitate to identify or distinguish various objects in an image. In an embodiment, the gray scale map of the image is being replaced by a color map having a set of color hue values, the color hue values being determined with reference to an effective light level.

An embodiment of the invention provides, a method for images visualization that utilizes the ability of sensitivity of human eye to different parts of the visible light spectrum, by showing radiological images at the most effective wavelengths between 450-650 nm. In an embodiment, color hue is obtained with reference to effective light level from a known region in the visible light spectrum and the obtained color hue is applied to an image.

In an embodiment, the display of monochromatic image is adjusted automatically with reference to the effective light.

In an embodiment, the monochromatic image is displayed with color hue, by converting the gray scale map of the image to a color map. A colored view is displayed and the color of the view is decided with reference to the effective light.

Although the invention is explained with reference to radiological images, the application of the invention may be extended to various other images or objects displayed electronically. The invention is currently explained with reference to medical image display system, however the display system could be any display system capable of displaying monochromatic images. The display systems could include other viewing technologies like night vision devices and a significant portion of modern aircraft digital display devices etc.

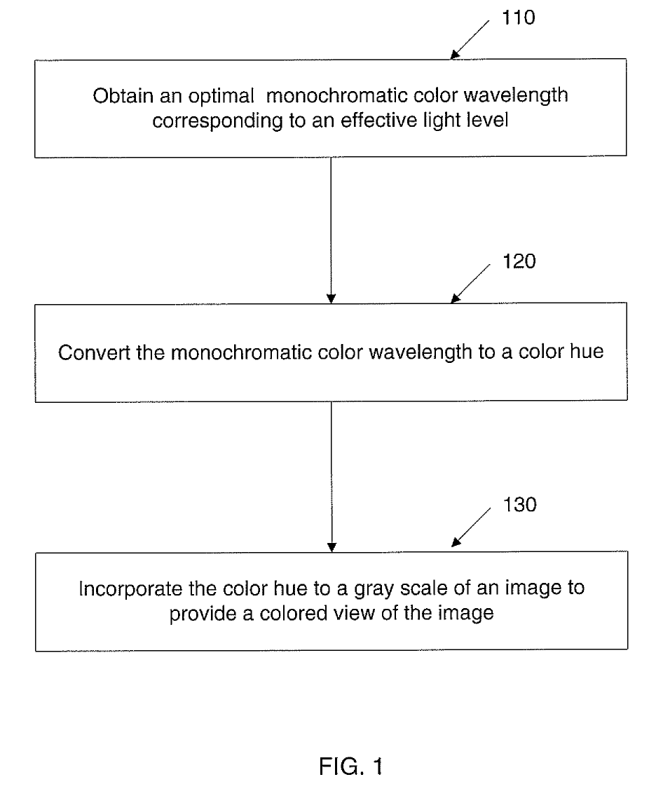

FIG. 1 is a flowchart illustrating a method of visualization of monochromatic images on a monitor as described in an embodiment of the invention. At step 110, an optimal monochromatic color wavelength is obtained with reference to an effective light level. The effective light level could be obtained by checking an ambient light level in a display room and a monitor light level indicating light level of a monitor on which the image is being displayed. The effective light level may be obtained by combining the ambient light level and the monitor light level. Based on the effective light level, corresponding optimal monochromatic color wavelength is obtained. The optimal monochromatic color wavelength obtained, will be a part of the visible light spectrum. At step 120, the optimal monochromatic color wavelength is converted to color hue. This could be achieved by using suitable algorithms configured to convert wavelengths to corresponding color hues. The color hue value includes red, blue, green values in a color. At step 130, the color hue is incorporated to the gray scale of the image to provide a colored view of the image. The color hue is selected with reference the optimal monochromatic color wavelength or the region of the visible spectrum where the optimal monochromatic wavelength falls in the visual spectrum. In an example, the spectrum region is selected in the range of 450 nm to 650 nm. The color hue is incorporated into the gray scale map of the image and this will help a viewer to differentiate various parts of the image. The gray scale map is changed to color map and the color map is used in rendering the colored view. Thus based on the effective light level, the color hues are identified and incorporated to the previously gray scale image.

In an embodiment, the color hue corresponding to the effective light is incorporated on to the image. The effective light being obtained with reference to the ambient light and the monitor light. In an embodiment, the color hue is selected from a region of the visual spectrum, the region being in the range of 450 nm to 650 nm.

In an embodiment, the optimal monochromatic color wavelength is obtained with reference to a standard such as Commission Internationale de l'Eclairge—International Commission on Illumination (CIE).

In an example, the colored view is a yellow green view at 555 nm in the event of a photopic vision. Alternately, the colored view could be a green view at 507 nm in the event of a scotopic vision.

Since ambient light levels used for radiology images reading vary between individual settings as well as within a single setting over time it is necessary to provide for a means of adjusting the monochromatic color wavelength to match the optimal sensitivity of the human eye at the given effective light level and according to the CIE luminous efficacy standard. In an embodiment, the color hue derived from the effective light, or the optimal monochromatic wavelength corresponding to the effective light, may be customized with reference to the user preference.

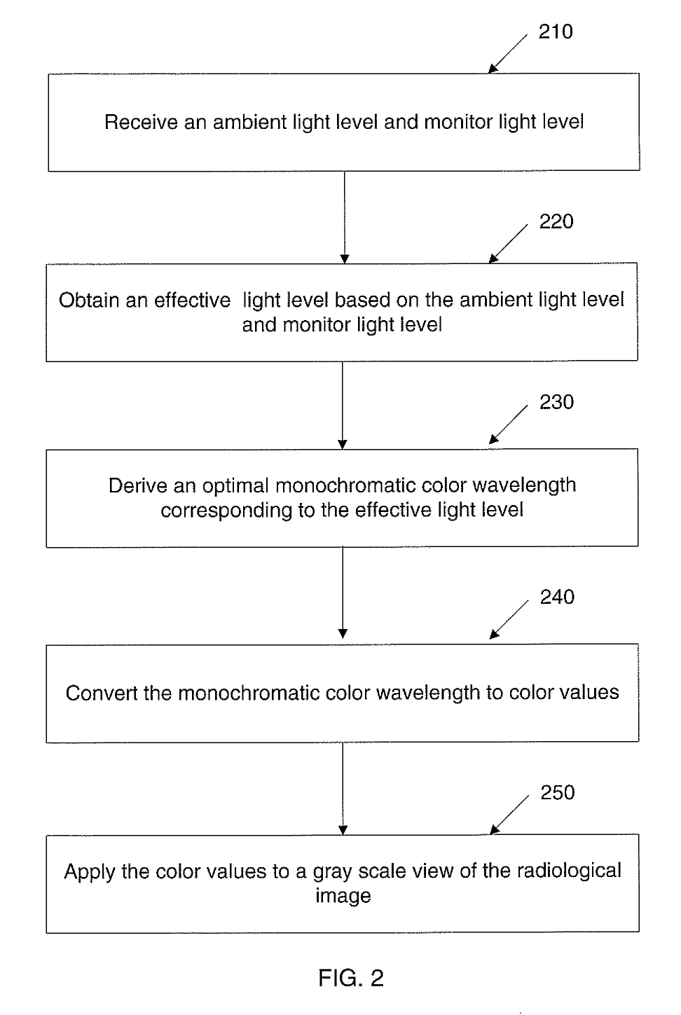

FIG. 2 is a flowchart illustrating a method of displaying radiological images as described in an embodiment of the invention. The method discloses displaying monochromatic radiological images in a color monitor. The radiological images may include medical as well as non-medical images from different imaging modalities. At step 210, an ambient light level and a monitor light level is obtained. The ambient light level is level of light available in a display room and a monitor light level indicates the light level of the monitor on which the image is being displayed. This may be obtained by using light sensors configured to identify ambient light in a display room and monitor light level of a monitor on which the image is being displayed. At step 220, an effective light level is obtained from the ambient light level and the monitor light level. This effective light level represents the available light level in the display room. Since the sensitivity of human eye to different parts of the visible spectrum is different, it will be beneficial to display the images in a color depending on the effective light level. At step 230, an optimal monochromatic color wavelength is derived corresponding to the effective light level. From defined relation between light and wavelength, the monochromatic color wavelength corresponding to the effective light may be obtained. At step 240, the monochromatic wavelength is converted to a color hue. The color hue represents the red, blue, green values of a color. The color hue value corresponding to the optimal monochromatic color wavelength is obtained. In an embodiment, a lookup table may be used to convert the optimal wavelength to color hue. At step 250, the color hue values are applied to gray scale map of the image. Thus the gray scale map is being converted to a color map. The color of the image is decided based on the effective light level. For example, in case of scotopic vision, or if the effective light level is low, the image may be applied with a green color and in case of photopic vision, or if the effective light is high, the image may be applied with an yellow-green color.

In an embodiment, the effective light level may be adjusted to select a desired range of the visible light spectrum. And based on the selected range of the spectrum, the color hue may be applied to the image.

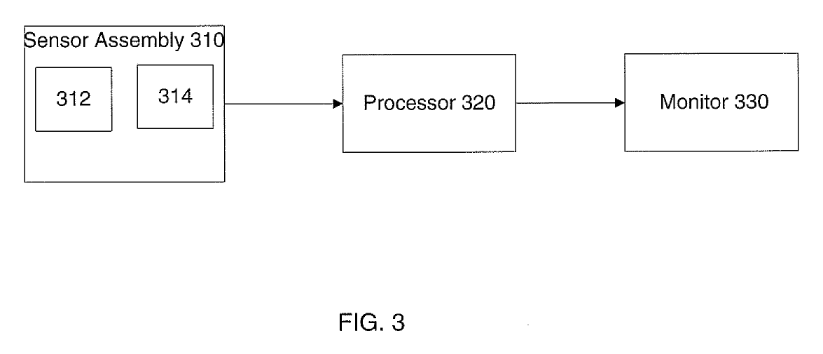

FIG. 3 is a block diagram illustrating a display system configured to display monochromatic images as described in an embodiment of the invention. The display system comprises: a sensor assembly 310, a processor 320 and a monitor 330. The sensor assembly 310 is configured to identify various light levels. The sensor assembly 310 could include plurality of light sensors. The sensor assembly 310 includes an ambient light sensor 312 configured to determine an ambient light level in a display room. The sensor assembly 310 further comprises a monitor light sensor 314 configured to identify the light level of a monitor. The monitor light sensor 314 may be a part of the monitor or could be installed separately. The ambient light level and the monitor light level are obtained by the ambient light sensor 312 and the monitor light sensor 314 respectively. Different light sensing devices may be used. The ambient light sensor 312 and monitor light sensor 314 need not be a single sensor, but could include array of sensors located at different parts of the room or the monitor.

The light level information from the sensing assembly 310, i.e., the ambient light level and monitor light level, may be fed to the processor 320 and the processor 320 may generate an effective light level. Alternately, the light levels may be combined by the sensor assembly 310 and an effective light level or effective luminous flux output may be sent to the processor 320. The processor 320 upon receiving or generating an effective light level, derives an optimal monochromatic color wavelength corresponding to the effective light level. The effective light level or the monochromatic color wavelength may be used in determining, the region of visible light spectrum on which the image need to be displayed so that the user can efficiently visualize different parts of the image.

Once the optimal monochromatic color wavelength is obtained, the wavelength is converted to a color hue by the processor 320. The color hue represents red, green and blue values of the color.

The processor 320 is further configured to apply the color hue to the gray scale map of an image and a colored view of the image is generated by converting the gray scale map of the image to color map. The colored view is displayed on the monitor 330. The color hue derived based on the effective light is incorporated into the color map of the image. Thus the image is displayed in color, the color being decided based on the effective light level.

In an exemplary embodiment, when the effective light level is high, or the effective light level higher than 3.4 cd/m2 or in the event of a photopic vision, the luminous efficacy is maximum (683 lumens/watt) at 555 nm wavelength. The photopic vision is primarily cone vision. In the visible light spectrum, the spectrum range between 495-570 represents green region and spectrum range between 570-590 represents a yellow region. Hence it will be appropriate to use a yellow-green color, if the effective light level is high.

In an exemplary embodiment, when the effective light level is low, the light level is less than 0.032 cd/m2, or in the event of a scotopic vision, the luminous efficacy is maximum (1700 lumens/watt) at 507 nm wavelength. The scotopic vision is primarily rod vision. In the visible light spectrum, the spectrum range between 495-570 represents green region. Hence it will be appropriate to use green color if the effective light level is low.

The processor, 320 is configured to determine the color hue based on spectrum region corresponding to the monochromatic color wavelength.

Dedicated hardware may be used instead of software and/or firmware for performing image processing, or a combination of dedicated hardware and software, or software in combination with a general purpose processor or a digital signal processor. Once the requirements for such software and/or hardware and/or dedicated hardware are gained from an understanding of the descriptions of embodiments of the invention contained herein, the choice of any particular implementation may be left to a hardware engineer and/or software engineer. However, any dedicated and/or special purpose hardware or special purpose processor is considered subsumed in the block labeled processor 320.

The monitor 330 may be any color display including CRT monitors, special monochrome monitors or PACS monitors.

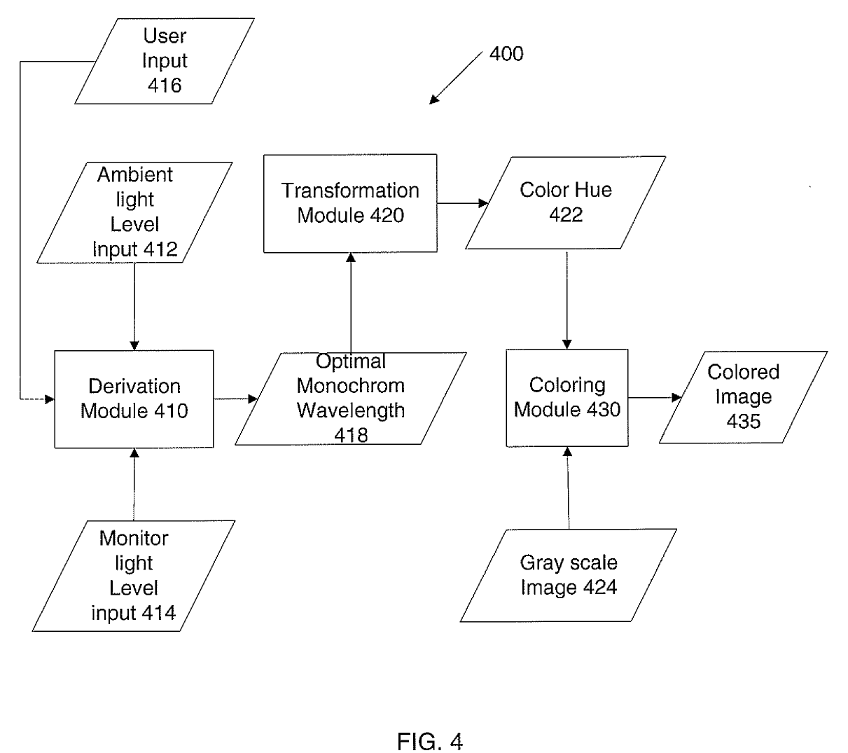

The processor 320 is configured to include different modules to perform various operations. The processor may include software and/or firmware (hereinafter referred to generically as “software”) can be used to instruct the computer to perform the inventive combination of actions described herein. Portions of the software may have specific functions and these portions are herein referred to as “modules” or “software modules.” However, in some embodiments, these modules may comprise one or more electronic hardware components or special-purpose hardware components that may be configured to perform the same purpose as the software module or to aid in the performance of the software module. Thus, a “module” may also refer to hardware or a combination of hardware and software performing a function. Some of these modules are explained in detail with reference to FIG. 4

FIG. 4 is a block diagram illustrating an image processing system configured to visualize monochromatic images in color hue as described in an embodiment of the invention. The image processing system 400 is configured to include a derivation module 410, transformation module 420 and coloring module 430. The derivation module 410 is configured to receive an ambient light sensor input 412 and monitor light sensor input 414. The derivation module 410 may derive an effective light level based on the inputs 412 and 414. Optionally a user input 416 may be provided to the derivation module 410 such that customization on the image processing may be achieved. The derivation module 410 may also be directly provided with the effective light level. The derivation module 410 is configured to derive an optimal monochromatic wavelength 418 with reference to the effective light. The optimal monochromatic wavelength 418 may be part or region of visible light spectrum. A suitable derivation technique may be used to a convert the effective light level to optimal monochromatic color wavelength 418. The optimal monochromatic color wavelength 418 is fed to a transformation module 420. The transformation module 420 is configured to transform the optimal monochromatic wavelength 418 to color hue 422. The color hue 422 represents the red, green, blue values in a color. In an example, the transformation module 420 is a lookup table. Suitable transformation technique may be used in converting the monochromatic color wavelength 418 to corresponding color hue 422. For example, if the monochromatic wavelength is 507 nm, the color could be green shade and if the monochromatic wavelength is 557 nm, the color could be yellow-green shade. The color hue value is provided to a coloring module 430. The coloring module 430 is also provided with the image 424 to be displayed. The image 424 is having a gray scale map. The coloring module is configured to change the gray scale map of the image to a color map. Any suitable incorporation technique may be used for this purpose. In an example, the color hue values are applied to gray scale map by changing white value in the gray scale map with the color values. A colored view 435 is generated (shown as shaded view), such that it could help a user to differentiate among different parts of the image.

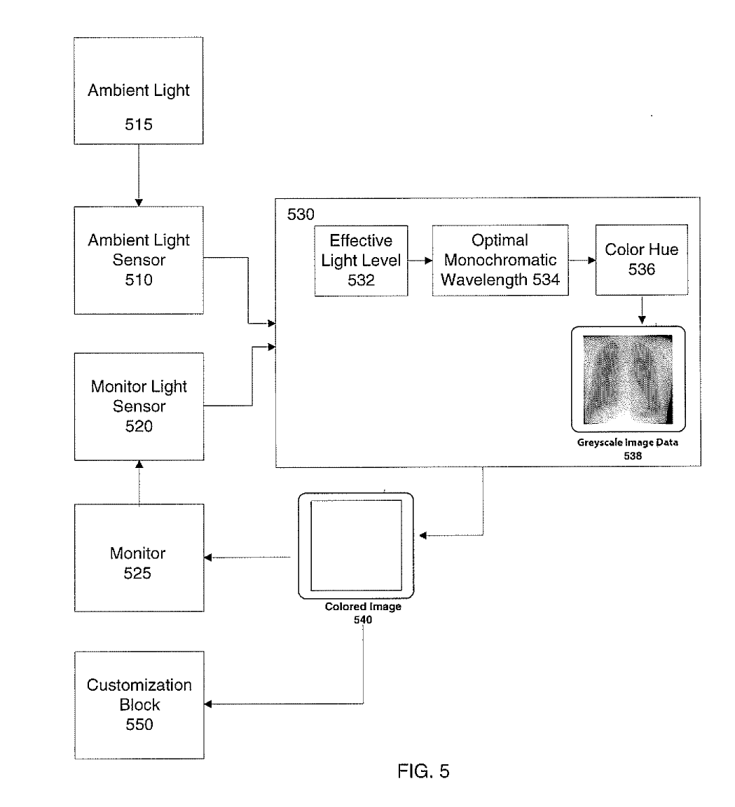

FIG. 5 is a schematic representation of a display system configured to display monochromatic images as described in an embodiment of the invention. An ambient light sensor 510 is provided to determine an ambient light level generated by an ambient light source 515. The ambient light level represents the light level available in a display room. A monitor 520 is provided to display an image. The monitor 520 is a color monitor with a desired light level setting. The monitor 520 is provided with a monitor light sensor 525 to identify the light intensity of the monitor display. The outputs of ambient light sensor 510 and the monitor light sensor 525 are provided to a processor 530. The processor 530 is configured to generate an effective light level 532. The effective light level 532 could be a combination of the ambient light level and the monitor light level. Once the effective light level 532 is decided, the processor 530 is further configured to convert the effective light level to an optimal monochromatic color wavelength 534. The optimal monochromatic color wavelength 534 is a part of the visible spectrum. The optimal monochromatic color wavelength 534 is being converted to a color hue 536 based on a color map. The color hue 536 corresponding to the spectrum range where the optimal monochromatic color wavelength 534 belongs, is selected. The color hue 536 or the red, blue, green values are incorporated on to the gray scale map of an image 538 and this results in a color-applied image 540. Optionally a customization block 550 may be provided, to adjust the ambient light level or wavelength or the user preferences.

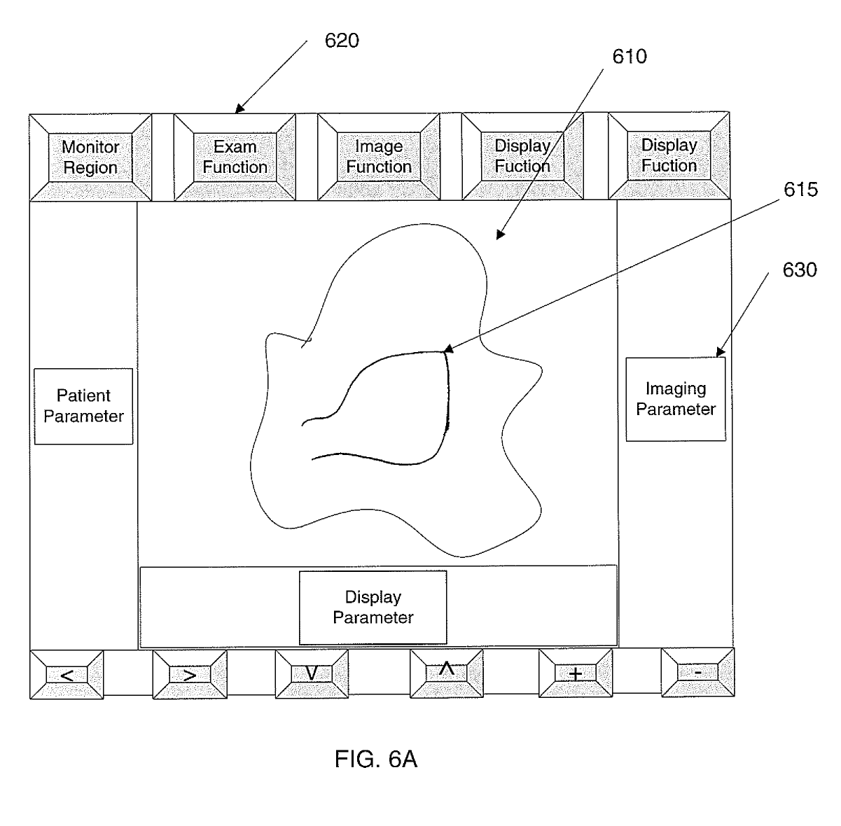

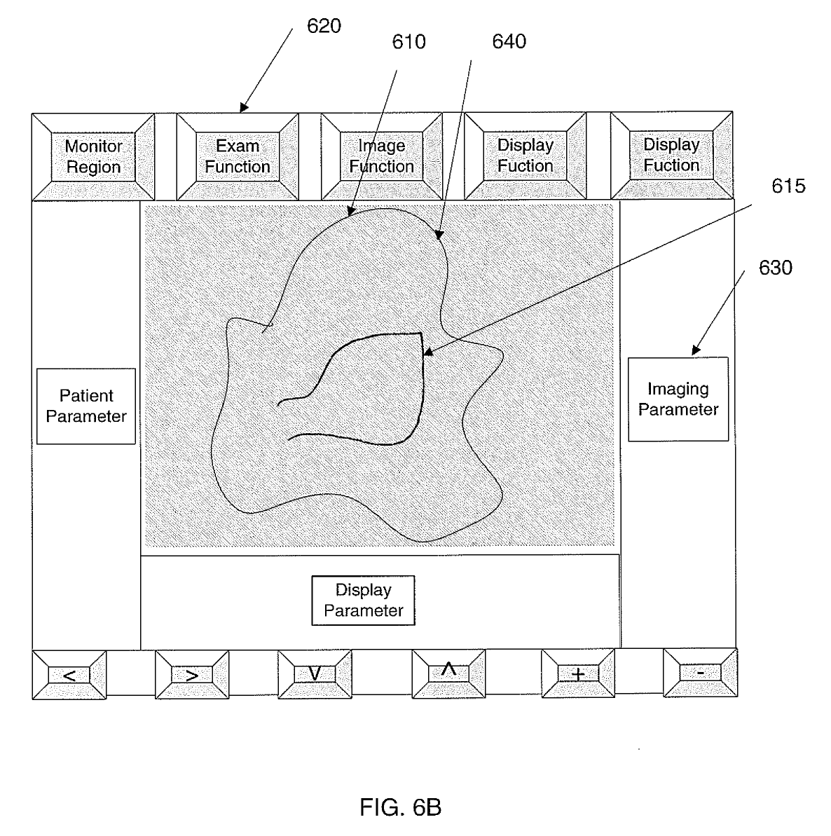

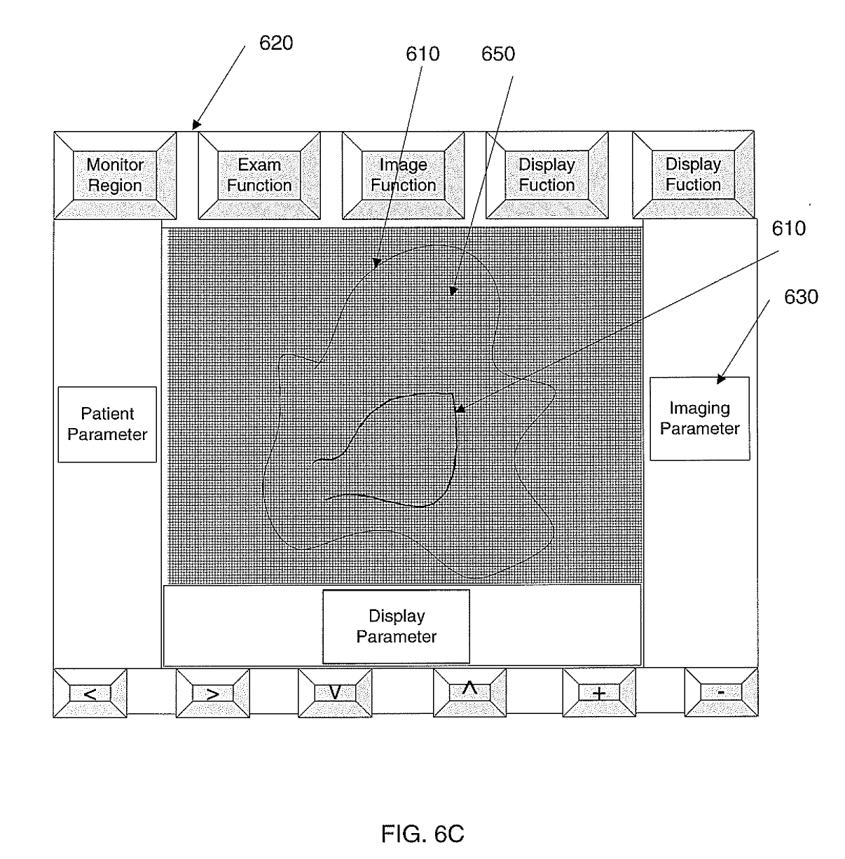

FIG. 6A to 6C illustrate a screenshot of an image in gray scale, and image views represented in color at different region in the visible spectrum. FIG. 6A shows an image 610 in its native state. A set of user interactive controls 620 may be provided on the display to control various parameters of imaging and display operation. In some embodiments, clinical parameters 630 such as patient parameters, imaging parameters, and display parameters may be displayed along with the image 610. The image 610 is being displayed in a gray scale view. Various soft tissues 615 on the image 610 are not easily identified from the image 610. FIG. 6B shows an image 610 displayed in a green color view. The green color view 640 is presented with a shading pattern having hatching lines. In an example, if the effective light level in the room is less than about 0.032 cd/m2, or in the event of a scotopic vision, the luminous efficacy is maximum (1700 lumens/watt) at 507 nm wavelength. During low ambient light level, a green color is provided on the gray scale map to make different tissues 615 in the image 610 more distinguishable. FIG. 6C shows an image displayed in a yellow-green color view. The yellow-green view 650 is represented with a shading pattern having crossed lines. In an example, if the effective light level in the room is more than about 3.4 cd/m2 or in the event of a photopic vision, the luminous efficacy is maximum (683 lumens/watt) at 555 nm wavelength. If the effective light level is high, then the gray scale map is applied with a yellow-green color. This will help in differentiating different tissues 615 in the image 610.

The advantages of the invention include increasing the ability to differentiate values in monochrome images and this will help a radiologist in identifying different parts of an anatomy. The ambient light level and the monitor light level is normally kept as a constant and hence no need to adjust these parameters to increase the differentiation of different parts of the image. The existing lower-priced color imaging monitors may be used but still enhanced differentiation of the images can be obtained. The invention helps to view radiology images on electronic form and the computer media with appropriate control helps a user for optimal monochrome viewing of radiological images on a medical equipment utilizing wavelengths in the range of 450-650 nm range on a color display monitor. By utilizing the strength of human perception, lower overall lumens may be as effective; lowering the need for specialized reading rooms. And by utilizing color information, specialized gray scale monochrome monitors may not be required.

The above-description of the embodiments of the methods and systems has the technical effect of displaying monochromatic images in color hue. This is particularly used in displaying radiological images in healthcare environment.

Thus various embodiments of the invention describe a method and system for visualizing monochromatic image with color hue.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Exemplary embodiments are described above in detail. The assemblies and methods are not limited to the specific embodiments described herein, but rather, components of each assembly and/or method may be utilized independently and separately from other components described herein. Further the steps involved in the workflow need not follow the sequence in which there are illustrated in figures and all the steps in the work flow need not be performed necessarily to complete the method.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

We claim:

1. A method of visualization of monochromatic images on a monitor comprising:
obtaining an optimal monochromatic color wavelength corresponding to an effective light level, the effective light level being identified with reference to an ambient light level and a monitor light level;
converting the monochromatic color wavelength to a color hue; and
incorporating the color hue to a gray scale map of an image to provide a colored view of the image.

2. A method as claimed in claim 1, wherein the ambient light level conveys the light level in a display room and the monitor light level conveys the light level of a monitor on which the image being displayed.

3. A method as claimed in claim 1, wherein the image is a radiological image.

4. A method as claimed in claim 1, wherein the color hue is selected from a known spectrum region of the visible light spectrum, the spectrum region being identified based on the effective light level.

5. A method as claimed in claim 4, wherein the color hue is selected from a spectrum region in the range of 450 nm to 650 nm.

6. A method as claimed in claim 1, wherein the colored view comprises: a yellow green view at 555 nm in the event of a photopic vision.

7. A method as claimed in claim 1, wherein the colored view comprises: a green view at 507 nm in the event of a scotopic vision.

8. A method as claimed in claim 1, wherein the step of incorporating the color hue comprises: converting the gray scale map of the image to a color map using the color hue.

9. A method as claimed in claim 8, further comprising: customizing the monochromatic color wavelength to adjust the color map of the image.

10. A method of displaying radiological images including:
receiving an ambient light level and a monitor light level;
obtaining an effective light level based on the ambient light level and monitor color level;
deriving an optimal monochromatic color wavelength corresponding to the effective light level;
converting the monochromatic color wavelength to color values; and
applying the color values to a gray scale map of the radiological image.

11. A method as claimed in claim 10, wherein the step of receiving the ambient light level and monitor color level comprises: providing light sensors to sense the ambient light level and the monitor light level.

12. A method as claimed in claim 10, wherein the step of deriving a monochromatic color wavelength comprises: selecting monochromic color wavelength corresponding to a region of visual spectrum.

13. A method as claimed in claim 12, wherein the region of spectrum includes: 450-650 nm.

14. A method as claimed in claim 10, wherein the step of converting the monochromatic color wavelength to color values comprises: converting monochromatic color wavelength to red, green, blue values.

15. A method as claimed in claim 10, wherein the step of applying color values to gray scale map comprises: replacing white value in the gray scale map with the color values.

16. A method as claimed in claim 15, wherein the step of applying color values to gray scale map comprises: providing a green color view at 507 nm corresponding to the gray scale map for scotopic vision.

17. A method as claimed in claim 14, wherein the step of applying color values to gray scale view comprises: providing a yellow-green color view at 555 nm corresponding to the gray scale map for photopic vision.

18. An image processing system configured to visualize monochromatic images in color hue, the system comprising:
a derivation module to derive an optimal monochromatic color wavelength with reference to an ambient light level and monitor light level;
a transformation module configured to convert the optimal monochromatic color wavelength to a color hue with reference to a spectrum range in the visual spectrum; and
a coloring module configured to change gray scale map of the image to a color map using the color hue;
wherein the derivation module, transformation module and coloring module are configured to operate together to visualize monochromatic images in color hue.

19. A system as claimed in claim 17, wherein the derivation module is configured to receive the ambient light level from an ambient light sensor and the monitor light level from a monitor light sensor.

20. A system as claimed in claim 17, wherein the transformation module is a lookup table.

21. A display system for displaying monochromic images comprising:
a sensing assembly including: an ambient light sensor and a monitor light senor;
a processor configured to:
derive an optimal monochromatic color wavelength with reference to an ambient light level and monitor light level;
convert the optimal monochromatic color wavelength to a color hue with reference to a spectrum range in the visual spectrum;
convert gray scale map of the monochromatic image to a color map using the color hue; and
a color monitor configured to display the monochromatic image with a color map.

22. A system as claimed in claim 20, wherein the spectrum range is from 450 nm to 650 nm.

23. A machine readable medium or media having recorded thereon instructions configured to instruct a system comprising: sensing assembly, a monitor and a processor to visualize monochromatic images in color hue comprising:
a routine for obtaining an optimal monochromatic color wavelength corresponding to an effective light level, the effective light level being identified with reference to an ambient light level and a monitor light level;
a routine for converting the optimal monochromatic color wavelength to color hue; and
a routine for incorporating the color hue to a gray scale map of an image to provided a colored view of the image
